(19) United States
(12) Patent Application Publication
(10) Pub. No.: US 2008/0090047 A1
(43) Pub. Date: Apr. 17, 2008

(54) Pile fabric having animal hair-like appearance

(76) Inventors: Minoru Kuroda, Hyogo (JP); Seiichi Sakurai, Hyogo (JP); Yoshinori Shibukawa, Hyogo (JP)

Correspondence Address: BRINKS HOFER GILSON & LIONE, P.O. BOX 10395, CHICAGO, IL, 60610, US

(21) Appl. No.: 11/906,893

(22) Filed: Oct. 4, 2007

Related U.S. Application Data
(62) Division of application No. 10/481,694, filed on Dec. 22, 2003, now abandoned.

(30) Foreign Application Priority Data
May 7, 2001 (JP) 2001-205079

(51) Int. Cl. B32B 33/00; B32B 3/02

(52) U.S. Cl. 428/89; 428/97

(57) ABSTRACT

The present invention provides a pile fabric comprising at least a long pile portion and a short pile portion to form a step, the pile fabric having a specific pile portion other than the long pile portion, which contains at least 3% by weight of an acrylic fiber (A) based on the entire pile portion, wherein the acrylic fiber (A) has a transmittance of light in a range of 15 to 70% in a direction of width of the fiber and a maximum surface reflectance of light in a range of 30 to 80% at an incident angle of 60 degrees in a direction of length of the fiber, and the pile fabric obtained thereby has an animal hair-like appearance with a distinct step.

### TECHNICAL FIELD

The present invention relates to a pile fabric having an animal hair-like appearance with distinct step effects.

### BACKGROUND ART

Acrylic fibers have animal hair-like texture and gloss and are widely used in the field of knit, boa, and high pile products. The recent demand is to make the appearance and the texture of pile closer to the natural fur by application of such acrylic fibers. The natural fur typically has a two-layer piloerecting structure including guard hair (stinging hair) and downy hair (fuzzy hair). The two-layer or multi-layer piloerecting structure is expected to give the appearance closer to the natural fur. Pile products of synthetic fibers have the similarly imitated two-layer structure.

An effective method of giving the two-layer structure to a pile fabric of synthetic fibers utilizes the discharge printing technique or the standard printing technique to change the color of the pile in a direction of length. This method, however, requires rather complicated processing and has difficulties in quality control, thus causing an undesirably high cost and not being suitable for general purposes.

The most common technique of producing the two-layer structure is thus to use both the guard hair (long fiber) and the downy hair (short fiber) for the pile fabric. The one concrete method is to use fibers of a different shrinkage percentage for the pile and makes the fibers to shrink at the stage of preliminary, finishing. The difference in shrinkage percentage produces the two-layer structure. This method gives the pile of the two-layer structure by a process is substantially similar to a usual process without requiring any special technique like the printing technique, and advantageously requires a low manufacturing cost. A lot of techniques have been proposed to use fibers of a different shrinkage percentage for the pile and to take advantage of the difference in shrinkage percentage in order to produce the pile having the two-layer structure. For example, Japanese Unexamined Patent Publications No. 62-85052, No. 62-58053, No. 62-97988, and No. 62-97989 have proposed the techniques of making a clear step between the fibers of the guard hair and the fibers of the downy hair to obtain the appearance close to the natural fur. The guard hair and the downy hair, however, typically have only a small difference of color, which leads to insufficient step effects. Even in the case of a sufficiently large difference of color, the mixture of shrinkable fibers and non-shrinkable fibers at the bottom causes an unclear boundary between the different fibers and does not have the emphasized visibility of the two-layer structure. The technique proposed in Japanese Unexamined Patent Publication No. 8-260289 uses a material of fibers having a small mutual friction coefficient and specifying the composition of the material and the differences of the fineness and the pile length in order to produce the pile of the two-layer structure having favorable texture. This technique, however, also causes an unclear boundary between the different fibers and does not attain the emphasized visibility of the two-layer structure. In order to give a clear boundary between different fibers on the bottom of the pile fabric having the two-layer structure, one possible method is to increase the number of downy hair. This, however, naturally decreases the number of guard hair, thus decreasing the number of fibers on the surface of the fabric and making the resulting pile fabric readily worn out.

### DISCLOSURE OF THE INVENTION

The object of the present invention is to provide a pile fabric having an animal hair-like appearance with distinct step effects by applying acrylic fibers having emphasized visibility of respective fibers to the downy hair.

The present invention is directed to a pile fabric comprising at least a long pile portion and a short pile portion to form a step, said pile fabric having a specific pile portion other than the long pile portion, which contains at least 3% by weight of an acrylic fiber (A) based on the entire pile portion, wherein the acrylic fiber (A) has a transmittance of light in a range of 15 to 70% in a direction of width of the fiber and a maximum surface reflectance of light in a range of 30 to 80% at an incident angle of 60 degrees in a direction of length of the fiber.

It is preferable that the acrylic fiber (A) has a width of a longitudinal axis in a range of 50 to 300 μm on cross section of the fiber.

It is preferable that the acrylic fiber (A) has a flat cross section.

It is preferable that the acrylic fiber (A) has a dry heat shrinkage rate of 10 to 50%.

Also the present invention is directed to a step pile fabric including the long pile portion, the medium pile portion and the short pile portion, wherein the medium pile portion and/or the short pile portion contain the acrylic fiber (A) in a range of 20 to 80% by weight based on the entire pile portion.

In the step pile fabric, it is preferable that the medium pile portion of the pile fabric contains the acrylic fiber (A) in a range of 20 to 50% by weight based on the entire pile portion.

The step pile fabric satisfies relations of |LM−LG|>40 and |LM−LS|>50, where LG, LM, and LS respectively denote a lightness of the long pile portion, a lightness of the medium pile portion, and a lightness of the short pile portion.

In the step pile fabric of this arrangement, it is preferable that a difference between a mean pile length of the long pile portion and a mean pile length of the medium pile portion is not less than 2 mm, the mean pile length of the medium pile portion is longer by at least 1 mm than a mean pile length of the short pile portion, and the mean pile length of the long pile portion ranges from 9 to 34 mm.

It is preferable that the mean pile length of the long pile portion ranges from 12 to 25 mm.

Also the present invention is directed to a step pile fabric including only the long pile portion and the short pile portion, wherein the short pile portion contains the acrylic fiber (A) in a range of 20 to 80% by weight based on the entire pile portion.

The step pile fabric of this embodiment satisfies a relation of |LS−LG|>50, where LG and LS respectively denote a lightness of the long pile portion and a lightness of the short pile portion.

In the step pile fabric of this embodiment, it is preferable that a difference between a mean pile length of the long pile portion and a mean pile length of the short pile portion is not less than 2 mm and the mean pile length of the long pile portion ranges from 6 to 34 mm.

It is preferable that the mean pile length of the long pile portion ranges from 12 to 25 mm.

In is preferable that the acrylic fiber (A) has a greater fineness than a mean fineness of a fiber of the long pile portion.

The acrylic fiber (A) preferably contains 1.2 to 30 parts by weight of a white pigment having a maximum particle size of not greater than 0.8 μm based on 100 parts by weight of an acrylic copolymer.

The white pigment is preferably titanium oxide.

### BRIEF DESCRIPTION OF THE DRAWINGS

FIG. 1 shows the location of incident light in measurement of optical transmittance of a fiber having a flat cross section.

FIG. 2 shows the location of incident light in measurement of optical transmittance of a fiber having an elliptical cross section.

FIG. 3 shows the location of incident light in measurement of optical transmittance of a fiber having a circular cross section.

FIG. 4 shows the location of incident light in measurement of optical transmittance of a fiber having a crisscross-shaped cross section;

FIG. 5 shows an orientation of a sample in measurement of maximum surface reflectance of light against a fiber.

FIG. 6 shows steps in a three-step pile.

### BEST MODE FOR CARRYING OUT THE INVENTION

The present invention is directed to a pile fabric comprising at least a long pile portion and a short pile portion to form a step, said pile fabric having a specific pile portion other than the long pile portion, the specific pile portion containing at least 3% by weight of an acrylic fiber (A) based on the entire pile portion, wherein the acrylic fiber (A) has a transmittance of light in a range of 15 to 70% in a direction of width of the fiber and a maximum surface reflectance of light in a range of 30 to 80% at an incident angle of 60 degrees in a direction of length of the fiber.

In the present invention, the transmittance of light in the direction of width of the fiber is measured by visible microscopic spectrophotometry. The visible microscopic spectrophotometry uses an apparatus including a microscope, a spectrometer, and optical fibers connecting the microscope with the spectrometer. An image magnified by an objective lens of the microscope is focused on an end plane of the optical fibers, so that light from a target site to be measured enters the optical fibers and is led through the optical fibers to the spectrometer, which receives and measures the spectrum of light.

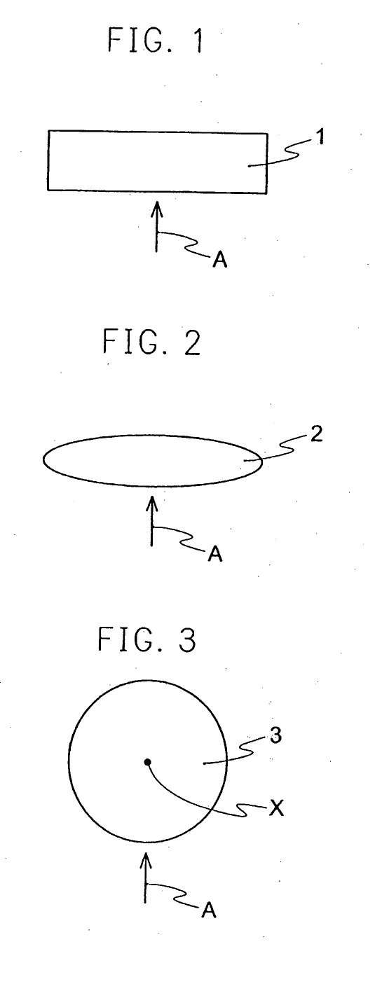

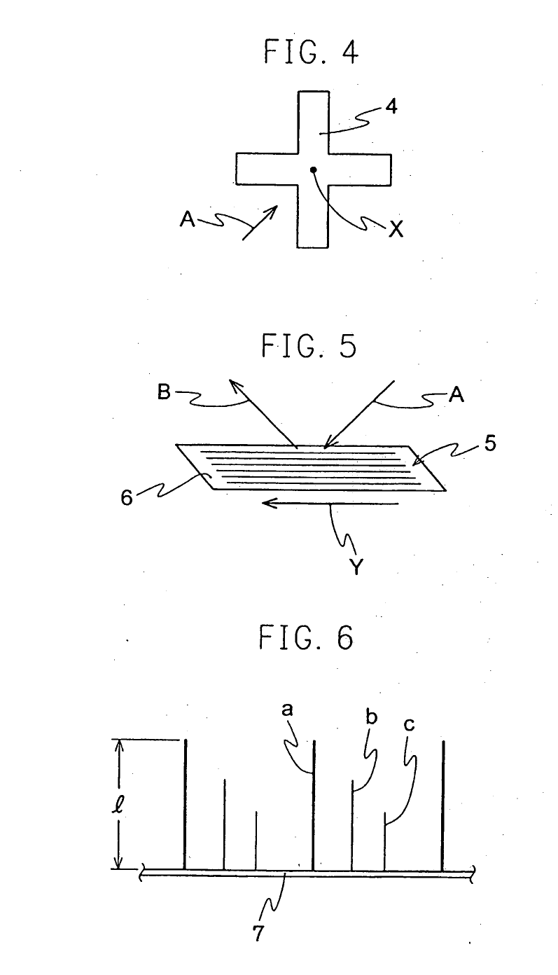

It is preferable to measure a beam of incident light A in a direction of width in a cross section of the fibers. For example, the incident light enters a maximum width of a shorter axis in a flat cross section 1, an elliptical cross section 2, and a dog bone-shaped cross section of the fibers (see FIGS. 1 and 2). The incident light enters a center of a circular cross section 3 and a triangular cross-section of the fibers (see FIG. 3). The incident light directly enters a center X in a crisscross-shaped cross section 4 and a Y-shaped cross section of the fibers (see FIG. 4).

The measurement is carried out in a visible light wavelength range of 400 to 700 nm. The incident light is required to have an optical transmittance in a range of 15 to 70% at a wavelength of 550 nm. The optical transmittance is preferably in a range of 15 to 65%, and more preferably in a range of 25 to 55%. The fibers having the optical transmittance of less than 15% do not have sufficient gloss and give “kempy wool-like impression. The “dead-hair”-like impression causes the low visual effects of the respective fibers and leads to the poor appearance. The optical transmittance of greater than 70%, on the other hand, gives the fibers “lack of hiding”, which causes an unclear boundary between fibers in the pile fabric. The unclear boundary does not have the emphasized visibility of the step between the long pile portion and the short pile portion and leads to the poor appearance. Fibers of a greater thickness relieve the “lack of hiding”. It is accordingly preferable to apply fibers of a greater thickness for a portion having a higher optical transmittance than the other portion, for example, in the case of the optical transmittance of not lower than 65%.

The maximum surface reflectance of the present invention is measured with an auto goniophotometer. The measurement irradiates a sample surface with light from a standard light source at a preset angle and measures a reflecting component of the light by a light receptor. A test procedure in conformity with JIS-K7105 is a typical method of the measurement.

The fiber of the present invention is required to have the maximum surface reflectance in a range of 30 to 80% when the light from the standard light source has an incident angle of 60 degrees in the direction of length of the fiber and the reflecting component is measured at a light reception angle of 0 to 90 degrees. The preferable maximum surface reference ranges from 40 to 70%. The maximum surface reflectance of less than 30% at the incident light angle of 60 degrees gives the insufficient gloss and the “kempy wool-like impression, which causes the low visual effects of the respective fibers and leads to the poor appearance. The maximum surface reflectance of greater than 80%, on the other hand, gives the fibers excessive gloss and the glare metallic impression on the surface of the fabric, which causes unclear step effects between the short pile portion and the long pile portion.

The acrylic fiber (A) applied for the pile fabric of the present invention has a width of a longitudinal axis on cross section of the fiber preferably in a range of 50 to 300 m and more preferably in a range of 70 to 200 μm. The upper limit is 300 μm. The width of greater than 300 μm emphasizes the significant planarity rather than the linearity of monofilaments and undesirably gives a fibrous film-like strange impression to the resulting pile fabric. The resulting pile fabric also has relatively rough touch and poor tactile impression. When the width of the longitudinal axis of the fiber is less than 50 μm, which is the lower limit, on the other hand, the visibility of the respective fibers is lowered. Such fibers even having the optical characteristics of the present invention do not give the distinct step effects to the resulting pile fabric, which accordingly has no significant difference from the prior art pile fabric. The less width of the longitudinal axis of the fiber also causes an insufficient volume and poor recovery of the resulting pile fabric, which accordingly has no significant difference from the prior art pile fabric.

Here the width of the longitudinal axis on cross section of the fiber represents a maximum distance between two parallel straight lines circumscribing the cross section of the fiber. The cross section of the fiber is not specifically restricted, but a flat cross section is preferable because of its good tactile impression. The fiber preferably has a flatting ratio, which is expressed as a ratio of the minimum width of the longitudinal axis to the maximum width of the shorter axis, in a range of 3 to 20. The flatting ratio of 10 to 18 is especially effective. The flatting ratio of less than 3 narrows the visually important fiber width and tends to lower the visibility of the respective fibers. The flatting ratio of higher than 20, on the other hand, undesirably emphasizes the transparency when the fiber is observed from a direction perpendicular to the longitudinal axis on cross section of the fiber.

The fineness of the fiber is preferably in a range of 3 to 30 decitex (hereafter abbreviated as dtex). The range of 5 to 20 dtex is especially preferable because of the distinct characteristics. The fineness of less than 3 dtex gives too thin fibers and causes the low visibility of the respective monofilaments and an unclear boundary between fibers in the resulting pile fabric. The thinner fibers also cause an insufficient volume and poor recovery of the resulting pile fabric, which accordingly has no significant difference from the prior art pile fabric. The fineness of greater than 30 dtex, on the other hand, forms a distinct step between fibers but gives the resulting pile fabric the poor texture.

A prior art technique of using fibers having different cut lengths may be applied to obtain the step pile fabric of the present invention. The mixture of fibers having different shrinkage percentages is, however, preferable to produce a distinct, tipping print-like step. The shrinkage percentage of the present invention is shown by dry heat shrinkage rate. The dry heat shrinkage rate is expressed as:

Dry heat shrinkage rate (%)=[(Lb−La)/Lb]×100 where Lb denotes a length of a sample fiber measured in a non-shrinking state under a load of 8.83×10⁻³ cN/dtex, and La denotes a length of the sample fiber in a shrinking state measured after heat treatment of 130° C.×20 minutes in a holding furnace under the condition of no load.

In order to ensure the sufficient volume and the sufficient step effects between the guard hair and the downy hair in the pile fabric, the acrylic fiber (A) included in the specific pile portion other than the long pile portion in the pile fabric of the present invention preferably has the dry heat shrinkage rate in the range of 10 to 50%. The more preferable range is 15 to 30% in the two-step pile fabric. In the three-step pile fabric, the dry heat shrinkage rate of the fiber in the short pile portion is to be greater than that of the fiber in the medium pile portion. In the case of application of the acrylic fiber (A) for the medium pile portion, the preferable range of the dry heat shrinkage rate is 10 to 30%. In the case of application of the acrylic fiber (A) for the short pile portion, on the other hand, the preferable range of the dry heat shrinkage rate is 35 to 50%. In either case, the acrylic fiber (A) having the dry heat shrinkage rate out of the above range has only a small difference in dry heat shrinkage rate from the fiber of the other pile portion. This causes unclear step effects. These conditions of the dry heat shrinkage rate are not essential when another method is applied to produce the step pile fabric.

The pile portion of the present invention represents a piloerecting layer of the pile fabric (piloerecting fabric), other than a ground cloth layer 7 (layer of ground yarns) as shown in FIG. 6. A pile length 1 represents a length from the root to the tip of the piloerecting layer.

The mean pile length is obtained by adjusting and raising the fibers of the pile portion of the pile fabric upright, measuring the length from the root to the tip of the respective fibers included in the pile portion (that is, from the root of the surface layer of the pile fabric) at 10 different positions, and calculating the mean of the 10 measurement points.

There are a diversity of pile fabrics, for example, a pile fabric of a fixed pile length and a pile fabric including a long pile portion and a short pile portion. The pile fabric of the present invention does not have specific restriction of the pile length but is a step pile fabric including at least a long pile portion and a short pile portion. Preferable examples of the step pile fabric include a three-step pile fabric including a long pile portion, a medium pile portion, and a short pile portion and a two-step pile fabric including only a long pile portion and a short pile portion. Four-step and greater-step pile fabrics are also available, but the greater number of steps may undesirably cause unclear steps.

In the three-step pile fabric shown in FIG. 6, for example, a long pile portion “a” represents a portion of a longest pile length (portion a) or a guard hair portion, a medium pile portion “b” represents a portion having a second longest pile length after the long pile portion “a” (portion b) or a middle hair portion, and a short pile portion “c” represents a portion having a shortest pile length (portion c) or a downy hair portion. In the four-step or greater-step pile fabric, the portion having the longest pile length is defined as the long pile portion “a”, the portion having the shortest pile length is defined as the short pile portion “c”, and the residual portions are collectively defined as the medium pile portion. The term “step” in the present invention means a difference between the portion “a” and the maximum pile length of the portion “b” (the longer pile length in the case of the two-step portion “b”) in the three-step pile fabric including the portion “a”, the portion “b”, and the portion “c”. In the two-step pile fabric including only the portion “a” and the portion “c”, the step means a difference between the portion “a” and the portion “c”.

The pile fabric of the present invention has the step described above and contains at least 3% by weight of the acrylic fiber (A) in the specific pile portion other than the long pile portion, based on the entire pile portion. The content of the acrylic fiber (A) is preferably not less than 20% by weight or more preferably not less than 30% by weight. The upper limit is 90% by weight or preferably 80% by weight. When the content of the acrylic fiber (A) in the specific pile portion other than the long pile portion is less than 3% by weight based on the entire pile portion, the resulting pile fabric has step effects substantially equivalent to those of the prior art pile fabric of shrinkable fibers. The content of greater than 90% by weight, on the other hand, causes the visual effects of the pile portion other than the long pile portion to be dominant on the appearance of the step pile fabric. This makes the step effects unclear and does not give the sufficient animal hair-like appearance. This also significantly reduces the guard hair portion and worsens the balance between the guard hair and the downy hair, thus making the resulting pile fabric readily worn out and lowering the commercial value of the pile fabric.

One preferable embodiment of the present invention is a step pile fabric including a long pile portion, a medium pile portion, and a short pile portion, wherein the acrylic fiber (A) is contained in the medium pile portion and/or in the short pile portion in a range of 20 to 80% by weight or more preferably in a range of 20 to 70% by weight based on the entire pile portion. When the content of the acrylic fiber (A) is less than 20% by weight, the resulting step pile fabric does not have distinct step effects. The content of greater than 80% by weight, on the other hand causes the visual effects of the medium pile portion and/or the short pile portion to be dominant on the appearance of the step pile fabric. This makes the step effects from the long pile portion unclear and does not give the sufficient animal hair-like appearance.

Another preferable embodiment of the present invention is a three-step pile fabric, wherein the acrylic fiber (A) is contained in the medium pile portion in a range of 20 to 50% by weight or more specifically in a range of 20 to 40% by weight based on the entire pile portion. When the content of the acrylic fiber (A) in the medium pile portion is less than 20% by weight, the medium pile portion has poor visibility on the appearance of the resulting step pile fabric. The resulting step pile fabric is thus substantially equivalent to the prior art two-step pile fabric of shrinkable fibers. When the content of the acrylic fiber (A) in the medium pile portion exceeds 50% by weight, on the other hand, the medium pile portion is undistinguishable from the long pile portion on the appearance of the resulting step pile fabric. The resulting step pile fabric is thus substantially equivalent to the prior art two-step pile fabric and gives the insufficient animal hair-like appearance.

Here the content of the acrylic fiber (A) represents the ratio of the weight of the acrylic fiber (A) to the entire pile portion. A mixture of the acrylic fiber (A) and another acrylic fiber may be applicable for the medium pile portion or the short pile portion.

The three-step pile fabric including the long pile portion, the medium pile portion, and the short pile portion has distinct steps and the significantly improved effects of the present invention, when lightness (LG) of the long pile portion, lightness (LM) of the medium pile portion, and lightness (LS) of the short pile portion satisfy conditions that the absolute difference between LG and LM is greater than 40, that is, |LM−LG|>40 and that the absolute difference between LS and LM is grater than 50, that is, |LM−LS|>50. Here it is more preferable to satisfy |LM−LG|>45 and |LM−LS|>55. When the condition of |LM−LG|>40 is not fulfilled, the resulting step pile fabric has a small difference of lightness between the long pile portion and the medium pile portion and accordingly an unclear step. This does not make the tipping print-like appearance. When the condition of |LM−LS|>50 is not fulfilled, the resulting step pile fabric has an observable step between the long pile portion and the medium pile portion but an unclear boundary between fibers of the medium pile portion and the short pile portion due to its small difference of lightness. This causes insufficient step effects and gives the poor appearance to the resulting three-step pile fabric.

The lightness L is a color scale measured by a calorimeter. In the present invention, the lightness L was measured by a colorimeter 190 manufactured by Nippon Denshoku Industries Co., Ltd., although other calorimeters may be used instead. The lightness L approaching to 100 represents a color closer to white, and the lightness L approaching to 0 represents a color changing from gray to black. Another color scale is chromaticities “a” and “b”, which are shown with “+” and “−” signs. The larger “+” value of chromaticity “a” has the greater degree of red, whereas the larger “−” value of chromaticity “a” has the greater degree of green. The larger “+” value of chromaticity “b” has the greater degree of yellow, whereas the larger “−” value of chromaticity “b” has the greater degree of blue. These scales L, a, and b are called the Hunter's Lab color system. The L value represents brightness and darkness of color and is suitably used as the scale contributing to the effects of the present invention.

In the three-step pile fabric, a step between the mean pile length of the fibers of the long pile portion and the mean pile length of the fibers of the medium pile portion is not less than 2 mm and is preferably not less than 3 mm. The mean pile length of the fibers of the medium pile portion is longer than the mean pile length of the fibers of the short pile portion preferably by at least 1 mm or more preferably by at least 2 mm. In order to attain the desired step effects in the three-step pile fabric, the mean pile length of the fibers of the long pile portion is in a range of 9 to 34 mm, preferably in a range of 12 to 28 mm, or more preferably in a range of 15 to 25 mm. When the step between the mean pile length of the fibers of the long pile portion and the mean pile length of the fibers of the medium pile portion is less than 2 mm, the resulting pile fabric does not sufficiently express the tipping print-like appearance but has the appearance similar to the conventional mixing appearance. When the difference between the mean pile length of the fibers of the medium pile portion and the mean pile length of the fibers of the short pile portion is less than 1 mm, the resulting three-step pile fabric has an unclear boundary between the medium pile portion and the short pile portion and is thus substantially similar to the conventional two-step pile fabric. When the mean pile length of the long pile portion is less than 9 mm, the resulting three-step pile fabric, which may satisfy the other constituent features of the present invention, does not have a distinct step, due to the excessively short pile length of the long pile portion. The mean pile length of greater than 34 mm, on the contrary, does not ensure the tipping print-like appearance of the resulting pile fabric.

Although the three-step pile fabric including the long pile portion, the medium pile portion, and the short pile portion is desirable, the step pile fabric may be a two-step pile fabric excluding the medium pile portion (middle hair). According to the above discussion, the appearance of the three-step pile fabric becomes similar to the appearance of the two-step pile fabric in the case where the content of the acrylic fiber (A), the difference of lightness, and the step are out of their preferable numerical ranges. This does not mean the two-step pile fabric is not preferable, but only shows that the deviation from the preferable ranges does not give expected effects as the three-step pile fabric.

Another embodiment of the present invention is a step pile fabric including only a long pile portion and a short pile portion, wherein the short pile portion contains the acrylic fiber (A) preferably in a range of 20 to 80% by weight or more preferably in a range of 30 to 70% based on the entire pile portion. When the content of the acrylic fiber (A) in the short pile portion is less than 20% by weight, the resulting pile fabric does not have distinct step effects. The content of greater than 80% by weight, on the other hand, causes the visual effects of the short pile portion to be dominant on the appearance of the step pile fabric. This makes the step effects from the long pile portion unclear and does not give the sufficient animal hair-like appearance.

The two-step pile fabric has a distinct step and the significantly improved effects of the present invention, when lightness (LG) of the long pile portion and lightness (LS) of the short pile portion satisfies a condition that the absolute difference between LG and LS is greater than 50, that is, |LS−LG|>50. When the condition of |LS−LG|>50 is not fulfilled, the resulting step pile fabric has a small difference of lightness between the long pile portion and the short pile portion and accordingly an unclear step. This does not make the tipping print-like appearance.

In this step pile fabric, a step between the mean pile length of the fibers of the long pile portion and the mean pile length of the fibers of the short pile portion is not less than 2 mm and is preferably not less than 3 mm. The mean pile length of the fibers of the long pile portion is in a range of 6 to 34 mm, preferably in a range of 9 to 28 mm, or more preferably in a range of 12 to 25 mm. When the step between the mean pile length of the fibers of the long pile portion and the mean pile length of the fibers of the short pile portion is less than 2 mm, the resulting pile fabric does not sufficiently express the tipping print-like appearance but has the appearance similar to the conventional mixing appearance. The mean pile length of the long pile portion that is less than 6 mm does not allow the step effects to be sufficiently observable and accordingly does not give the remarkable effects of the present invention to the resulting pile fabric, which may have a significant step. The mean pile length of greater than 34 mm, on the contrary, does not ensure the tipping print-like appearance of the resulting pile fabric.

As described previously, in order to relieve the “lack of hiding” impression, it is preferable that the acrylic fiber (A) of a high optical transmittance has a greater thickness than those of other fibers. Even when the acrylic fiber (A) does not have a high optical transmittance, it is preferable that the acrylic fiber (A) has a greater thickness than the mean thickness of the fibers of the long pile portion. The thicker acrylic fibers (A) are prominent in the resulting pile fabric so as to improve its appearance and advantageously give a sufficient volume and good recovery to the resulting pile fabric.

The acrylic fiber (A) or the shrinkable acrylic fiber of the present invention represents a fiber of an acrylic polymer. A preferable example is a copolymer including 35 to 98% by weight of acrylonitrile, 65 to 2% by weight of another vinyl monomer copolymerizable with acrylonitrile, and 0 to 10% by weight of a sulfonic acid group-containing vinyl monomer copolymerizable with acrylonitrile and the vinyl monomer. It is preferable that the content of acrylonitrile ranges from 35 to 90% by weight.

Typical examples of the vinyl monomer copolymerizable with acrylonitrile include vinyl halides and vinylidene halides like vinyl chloride, vinylidene chloride, vinyl bromide, and vinylidene bromide, unsaturated carboxylic acids and their salts like acrylic acid and methacrylic acid, acrylates and methacrylates like methyl acrylate and methyl methacrylate, esters of unsaturated carboxylic acids like glycidyl methacrylate, vinyl esters like vinyl acetate and vinyl butyrate, vinyl amides like acrylamide and methacrylamide, known vinyl compounds like methallylsulfonic acid, vinylpyridine, methyl vinyl ether, and methacrylonitrile, and acrylic copolymers obtained by copolymerization of one or plurality of these compounds.

Available examples of the sulfonic acid group-containing vinyl monomer include styrenesulfonic acid, p-styrenesulfonic acid, allylsulfonic acid, methallylsulfonic acid, p-methacryloyloxybenzenesulfonic acid, methacryloyloxypropylsulfonic acid, metal salts thereof, and amine salts thereof.

The white pigment of the present invention is an additive of a fine powdery inorganic compound. Specific examples include titanium oxide, zinc oxide, zirconium oxide, tin oxide, aluminum oxide, silicon oxide, magnesium oxide, calcium oxide, antimony oxide, titanium hydroxide, zinc hydroxide, zirconium hydroxide, aluminum hydroxide, magnesium hydroxide, lead hydroxide, barium sulfate, calcium sulfate, zinc sulfide, aluminum phosphate, calcium phosphate, calcium carbonate, lead carbonate, barium carbonate, and magnesium carbonate.

In the present invention, 1.2 to 30 parts by weight of or preferably 2 to 15 parts by weight of the white pigment, which has dispersibility and the maximum particle size of not greater than 0.8 μm, are added to 100 parts by weight of the acrylic polymer. The white pigment having the maximum particle size of greater than 0.8 μm causes aggregation of the white pigment dispersed in the liquid mixture. The aggregation lowers the filtering power and may damage stable continuous production in the industrial field.

The acrylic fiber obtained by addition of the white pigment having the maximum particle size of greater than 0.8 μm has a low hiding power. This does not visually emphasize the special color development in the resulting pile fabric.

The content of the white pigment that is less than 1.2 parts by weight increases the transparency of monofilaments. The resulting pile fabric gives an unclear boundary between monofilaments, due to a small difference of lightness and the “lack of hiding”, and accordingly does not have the emphasized appearance. The content of greater than 30 parts by weight, on the other hand, has adverse effects on the mechanical properties of the resulting fibers and undesirably lowers the productivity.

A preferable example of the white pigment is titanium oxide having a high refractive index and a high hiding power.

The present invention will be described in detail by way of examples, although the present invention is not restricted to these examples in any sense. Prior to description of the respective examples, conditions of measurements and analyses and evaluation methods are explained below.

(A) Measurement of Optical Transmittance

The optical transmittance of various monofilaments under a fixed lightness condition were evaluated with a metal microscope manufactured by Olympus Optical Co., Ltd. with regard to 5 samples and 2 different positions for each sample, that is, a total of 10 points. The magnifying power of the object lens was set to 50 fold (N.A.=0.70, β=89°), and the measurement area was 20 μm. A transmission-type bright-field halogen lamp was used as a light source. A multi-channel spectrophotometer MCPD-113 manufactured by Otsuka Electronics Co., Ltd. was used as a spectroscope, and measurement was performed in a visible light range of 400 to 700 nm at a resolution of 2.4 nm. The integration time limit was 20000 msec and the number of integrations was set to 4 times. A mean of the measurements was used as the observed value.

Desired locations of incident light A entering various shapes of cross sections are shown in FIGS. 1 through 4.

(B) Measurement of Maximum Surface Reflectance

For evaluation of the surface gloss, the maximum surface reflectance was measured with regard to the respective samples under a fixed lightness with an auto goniophotometer GP-200 manufactured by Murakami Color Research Laboratory. With reference to JIS-K7105, the measurement procedure evenly set fibers 5, which had a sample length of 50 mm and a total fineness of 30 thousand dtex, along a sample length direction Y on a sample table 6 and made light enter the fibers 5 at an incident angle of 60 degrees. The reflected light B was measured under the conditions of a light-receiving diaphragm of 4.5 mm, light-receiving angle of 0 to 90 degrees, and a light-receiving rotational angular velocity of 180 degrees/min. A standard light source was a halogen lamp of 12 V, 60 W. A voltage applied to a photomultiplier was set to −593 V.

The directions of incident light A and reflected light B relative to a target sample are shown in FIG. 5.

(C) Measurement of Width of Longitudinal Axis on Cross Section of Fiber

Each resulting bundle of fibers was packed in a silicone tube of 2.2 to 2.6 mm in bore and was cut perpendicularly to the direction of the axis of the fibers. The cut surface was subjected to vacuum deposition and was photographed to have approximately 50 cross sections of fibers with a scanning electron microscope. Then 30 cross sections were extracted at random, the width of the longitudinal axis on each extracted cross section was measured, and the mean of the widths of the 30 longitudinal axes was determined to be the of the longitudinal axis on cross section of fiber.

(D) Measurement of Lightness (L Value)

A fixed weight of pile fabrics was sampled from the portion of the pile fabric, and located each weighed sample on a sample plate of 30 mm in diameter, and measured the lightness of each sample with a colorimeter Σ90 (manufactured by Nippon Denshoku Industries Co., Ltd.), which was equipped with a light source in conformity with a standard light source C in JIS Z 8720. A sample cell loaded with sample cotton adjusted to have a cotton density of 0.16 g/cm³ was used for measurement of the L value.

(E) Measurement of Particle Size Distribution

The particle size distribution of the white pigment was measured with a transmission-type centrifugal sedimentation particle size analyzer SA-CP4L manufactured by Shimadzu Corporation. A solution was prepared by dissolving Discol 206 (generic name: polyalkylene oxide polyamine) manufactured by Dai-ichi Kogyo Seiyaku Co., Ltd. in acetone, was regulated to have a specific gravity of 0.814 g/cm³ and a viscosity of 0.798 mpa, and was filled in a preset cell. The measurement was conducted by adding 10 mg of pigment dispersed at a concentration of 1.5% by weight in acetone dropwise to the solution. The addition of the dispersion liquid of the pigment to the acetone solution of Discol 206 was to increase the viscosity of the dispersion liquid and thereby lower the sedimentation speed.

(F) Production of High Pile Fabric

Fibers obtained were subjected to required processing and operations including application of an oil solution, mechanical crimping, and cutting. Fibers having different dry heat shrinkage rates were used as the materials for a step pile fabric. Although the method of crimping is not particularly limited, the mechanical crimping, for instance, can gives crimps by a known method like a gear crimping method or a stuffing box method. The mechanical crimping preferably gave a crimping rate of 4 to 15% or preferably of 5 to 10% and the number of crimps in a range of 6 to 15 crimps/inch or preferably in a range of 8 to 13 crimps/inch, although these values are not restrictive. The crimping rate was obtained by a measurement method, for example, a method in conformity with JIS-L1074.

The resulting fibers were cut and woven with a sliver knitting machine to pile fabrics. Each woven pile fabric underwent a pre-polishing process and a pre-shirring process at 120° C. After adjustment of the pile length, the rear face of the pile fabric was coated with an acrylic ester adhesive. The heat applied for coating caused a step on the pile fabric, since the different fibers had different dry heat shrinkage rates. The coated pile fabric was successively subjected to a polishing process at 155° C., a brushing process at 155° C., and a combination process of polishing and shirring at 135° C., 120° C., and 90° C. (each process was repeated twice). The crimps on the surface of the piloerecting layer were removed resulting in a piloerecting fabric having a fixed pile length and a step.

(G) Sensory Evaluation of Appearance

Each pile fabric thus obtained was visually and sensuously evaluated with regard to the animal-like appearance having emphasis of a distinct step. The sensory evaluation was carried out in the following four grades:

⊚ (Excellent): Having a remarkably distinct step and the very good animal hair-like appearance;

◯ (Good): Having a distinct step and the good animal hair-like appearance;

Δ (Ordinary): Having a relatively unclear step and the poor animal hair-like appearance; and

X (Poor): Having a relatively unclear step and the extremely poor animal hair-like appearance.

(H) Measurement of Mean Pile Length

The fibers of a pile portion in each pile fabric were adjusted and raised upright. The length between the root and the tip of the fibers in the pile portion (this was not the length from the rear face of the pile fabric) was measured with a slide caliper at 10 different locations. The mean of the measurement values was defined as the mean pile length.

(I) Measurement of Step in Pile

The step of each pile is a difference between the mean pile length of the long pile portion and the mean pile length of the short pile portion, which were measured according to the above method, and was calculated as:
Step(mm)=Mean Pile Length(mm) of Long Pile Portion−Mean Pile Length(mm) of Short Pile Portion

### PRODUCTION EXAMPLES 1 AND 2

A spinning solution was prepared by dissolving an acrylic copolymer comprising 49% by weight of acrylonitrile, 50% by weight of vinyl chloride and 1% by weight of sodium styrene sulfonate in acetone and adding 2.3 parts by weight of titanium oxide (A-160 manufactured by Sakai Chemical Industry Co., Ltd.) having a maximum particle size of 0.8 μm and an excellent dispersibility to 100 parts by weight of the acrylic copolymer. The spinning solution was passed through a spinneret having a pore diameter of 0.06×0.8 mm and the number of pores of 3900 (Production Example 1) or through a spinneret having a pore diameter of 0.04×0.65 mm and the number of pores of 7133 (Production Example 2). The spinning solution passing through each spinneret was wet spun into a coagulation bath filled with an aqueous solution having an acetone concentration of 30%, successively went through two baths filled with aqueous solutions respectively having acetone concentrations of 35% and 25% to give 2.0-fold orientation, and then went through a washing bath at 90° C. to complete a total of 3.0-fold primary orientation. After application of an oil solution, the resulting fibers were dried in an atmosphere of 125° C. and were further oriented at 125° C. to have a final draft of 6.0 fold. Obtained were shrinkable fibers having a monofilament fineness of 17 dtex (Production Example 1) and shrinkable fibers having a monofilament fineness of 7.8 dtex (Production Example 2). The shrinkable fibers obtained in Production Example 1 had a flat cross section and a flatting ratio of 14.2. The shrinkable fibers obtained in Production Example 2 had a flat cross section and a flatting ratio of 12.2.

### PRODUCTION EXAMPLE 3

A spinning solution having a polymer concentration of 25% was prepared by dissolving an acrylic copolymer comprising 93% by weight of acrylonitrile and 7% by weight of vinyl acetate in dimethylacetamide (hereinafter referred to as DMAc) and adding 5 parts by weight of titanium oxide having a maximum particle size of 0.8 μm and an excellent dispersibility to 100 parts by weight of the acrylic copolymer. The spinning solution was passed through a spinneret having a pore diameter of 0.06×0.8 mm and the number of pores of 3900, was wet spun into a coagulation bath filled with an aqueous solution having a DMAc concentration of 60% by weight, and was oriented to 2.0 fold with washing of the solvent in boiling water. After application of an oil solution, the resulting filaments were dried with a heat roller of 130° C. and were further oriented to 2.0 fold in hot water of 70° C. Obtained were shrinkable fibers having a monofilament fineness of 17 dtex. The shrinkable fibers obtained in Production Example 3 had a flat cross section and a flatting ratio of 14.3.

### PRODUCTION EXAMPLE 4

A spinning solution was prepared by adding 1.0 part by weight of titanium oxide having a maximum particle size of 0.8 μm and an excellent dispersibility to 100 parts by weight of the acrylic copolymer of Production Example 3. The spinning solution was wet spun in the same manner as Production Example 3. Obtained were shrinkable fibers having a monofilament fineness of 17 dtex. The shrinkable fibers obtained in Production Example 4 had a flat cross section and a flatting ratio of 14.3.

### PRODUCTION EXAMPLE 5 AND 6

Spinning solutions were prepared by adding no titanium oxide (Production Example 5) and by adding 0.3 parts by weight of titanium oxide having a maximum particle size of 0.8 μm (Production Example 6) and an excellent dispersibility to 100 parts by weight of the acrylic copolymer of Production Example 1. Each of the spinning solutions was wet spun in the same manner as Production Example 1. This respectively gave shrinkable fibers having a monofilament fineness of 17 dtex. The shrinkable fibers obtained in Production Example 5 had a flat cross section and a flatting ratio of 13.5. The shrinkable fibers obtained in Production Example 6 had a flat cross section and a flatting ratio of 14.0.

### PRODUCTION EXAMPLE 7

A spinning solution was prepared by adding no titanium oxide to 100 parts by weight of the acrylic copolymer of Production Example 1. The spinning solution was wet spun in the same manner as Production Example 2. This gave shrinkable fibers having a monofilament fineness of 7.8 dtex. The shrinkable fibers obtained in Production Example 7 had a flat cross section and a flatting ratio of 12.2. Table 1 shows characteristic values of the resulting fibers.

TABLE 1

| | | | Addition of White | | Width of |
|---|---|---|---|---|---|
| | Polymer | | Pigment (parts by | Fineness | Longitudinal Axis |
| | Composition | Solvent | weight) | (dtex) | (μm) |
| Production | AN/VCL | Acetone | 2.3 | 17 | 189 |
| Example 1 | | | | | |
| Production | AN/VCL | Acetone | 2.3 | 7.8 | 100 |
| Example 2 | | | | | |
| Production | AN/VCL | DMAc | 5.0 | 17 | 190 |
| Example 3 | | | | | |
| Production | AN/VCL | DMAc | 1.0 | 17 | 192 |
| Example 4 | | | | | |
| Production | AN/VCL | Acetone | 0 | 17 | 182 |
| Example 5 | | | | | |
| Production | AN/VCL | Acetone | 0.3 | 17 | 185 |
| Example 6 | | | | | |
| Production | AN/VCL | Acetone | 0 | 7.8 | 101 |
| Example 7 | | | | | |

| | Shrinkage | Optical | Maximum Surface | | Maximum Particle |
|---|---|---|---|---|---|
| | Rate | Transmittance | Reflectance | | Diameter of White Pigment |
| | (%) | (%) | (%) | L Value | (μm) |
| Production | 27 | 49.5 | 74.5 | 93.8 | Not greater than 0.8 |
| Example 1 | | | | | |
| Production | 23 | 53.5 | 65.0 | 95.4 | Not greater than 0.8 |
| Example 2 | | | | | |
| Production | 29 | 42.0 | 72.0 | 94.8 | Not greater than 0.8 |
| Example 3 | | | | | |
| Production | 26 | 69.5 | 39.5 | 93.9 | Not greater than 0.8 |
| Example 4 | | | | | |
| Production | 25 | 95.0 | 90.0 | 85.1 | — |
| Example 5 | | | | | |
| Production | 24 | 70.2 | 42.0 | 92.2 | Not greater than 0.8 |
| Example 6 | | | | | |
| Production | 24 | 95.5 | 88.0 | 87.0 | — |
| Example 7 | | | | | |

(Note)
AN, VCL, and VAc of the polymer composition in the table respectively represent acrylonitrile, vinyl chloride, and vinyl acetate.

TABLE 2

| | Fibers and Rates | | | | Rate of | |
|---|---|---|---|---|---|---|
| | Long Pile | Medium Pile | Short Pile | | Acrylic | |
| | Portion | Portion | Portion | | Fiber (A) to | Mean Pile |
| | (parts by | (parts by | (parts by | Pile | Whole Pile (% | Length |
| | weight) | weight) | weight) | Structure | by weight) | (mm) |
| Example 1 | RLM (30) | Production | AHD (30) | 3-Tone | 40 | 20 |
| | | Example 1 (40) | | | | |
| Example 2 | RLM (30) | Production | AHD (30) | 3-Tone | 40 | 20 |
| | | Example 3 (40) | | | | |
| Example 3 | RLM (30) | Production | AHD (30) | 3-Tone | 40 | 20 |
| | | Example 4 (40) | | | | |
| Example 4 | RCL: Dyed (20) | — | Production | 2-Tone | 80 | 15 |
| | | | Example 2 (80) | | | |
| Comparative | RLM (30) | Production | AHD (30) | 3-Tone | 0 | 20 |
| Example 1 | | Example 5 (40) | | | | |
| Comparative | RLM (30) | Production | AHD (30) | 3-Tone | 0 | 20 |
| Example 2 | | Example 6 (40) | | | | |
| Comparative | RCL: Dyed (20) | — | AHP (80) | 2-Tone | 0 | 15 |
| Example 3 | | | | | | |
| Comparative | RCL: Dyed (20) | — | V85 (80) | 2-Tone | 0 | 15 |
| Example 4 | | | | | | |
| Comparative | AH (60) | — | Production | 2-Tone | 0 | 15 |
| Example 5 | | | Example 7 (40) | | | |

| | Difference in Mean Pile Length | | | |
|---|---|---|---|---|
| | between Long Pile Portion and | Difference in Mean Pile Length | | |
| | Medium Pile Portion or between | between Medium Pile Portion | LM − LG and | Appearance |
| | Long Pile Portion and Short | and Short Pile Portion | LM − LS or | of Pile |
| | Pile Portion (Step I) (mm) | (Step II) (mm) | LS − LG | Fabric |
| Example 1 | 5.0 | 3.0 | 93.8 − 29.6 = 64.2 | ⊚ |
| | | | 93.8 − 14.2 = 79.6 | |
| Example 2 | 5.0 | 3.0 | 94.8 − 29.6 = 65.2 | ⊚ |
| | | | 94.8 − 14.2 = 80.6 | |
| Example 3 | 5.0 | 3.0 | 93.9 − 29.6 = 64.3 | ⊚ |
| | | | 93.9 − 14.2 = 79.7 | |
| Example 4 | 3.0 | — | 95.4 − 34.6 = 60.8 | ◯ |
| Comparative | 5.0 | 3.0 | 85.1 − 29.6 = 55.5 | X |
| Example 1 | | | 85.1 − 14.2 = 70.9 | |
| Comparative | 5.0 | 3.0 | 92.2 − 29.6 = 62.6 | Δ |
| Example 2 | | | 92.2 − 14.2 = 78.0 | |
| Comparative | 5.0 | — | 92.7 − 34.6 = 58.1 | X |
| Example 3 | | | | |
| Comparative | 5.0 | — | 90.8 − 34.6 = 56.2 | X |
| Example 4 | | | | |
| Comparative | 3.0 | — | 87.0 − 17.1 = 69.9 | X |
| Example 5 | | | | |

### EXAMPLES 1 TO 3

The fibers obtained in Production Example 1, Production Example 3, and Production Example 4 were crimped and cut to 44 mm. Pile fabrics were obtained by blending 40 parts by weight of the shrinkable fiber obtained in Production Example 1, 30 parts by weight of a commercially available acrylic fiber Kanekalon (registered trademark) RLM (BR517) (12 dtex, 44 mm, manufactured by Kaneka Corporation), and 30 parts by weight of another commercially available acrylic fiber Kanekalon (registered trademark) AHD (10) (4.4 dtex, 32 mm, manufactured by Kaneka Corporation) (Example 1), by blending 40 parts by weight of the shrinkable fiber obtained in Production Example 3, 30 parts by weight of the commercially available acrylic fiber Kanekalon (registered trademark) RLM (BR517) (12 dtex, 44 mm, manufactured by Kaneka Corporation), and 30 parts by weight of the commercially available acrylic fiber Kanekalon (registered trademark) AHD (10) (4.4 dtex, 32 mm, manufactured by Kaneka Corporation) (Example 2), and by blending 40 parts by weight of the shrinkable fiber obtained in Production Example 4, 30 parts by weight of the commercially available acrylic fiber Kanekalon (registered trademark) RLM (BR517) (12 dtex, 44 mm, manufactured by Kaneka Corporation), and 30 parts by weight of the commercially available acrylic fiber Kanekalon (registered trademark) AHD (10) (4.4 dtex, 32 mm, manufactured by Kaneka Corporation) (Example 3). The respective long pile portions had a mean pile length of 20 mm. Each of the pile fabrics of Examples 1 through 3 had a remarkably distinct step and the very good animal hair-like appearance according to the results of the sensory evaluation of the appearance as shown in Table 2.

### COMPARATIVE EXAMPLES 1 and 2

The fibers obtained in Production Example 5 and Production Example 6 were crimped and cut to 44 mm. Pile fabrics were obtained by blending 40 parts by weight of the shrinkable fiber obtained in Production Example 4, 30 parts by weight of the commercially available acrylic fiber Kanekalon (registered trademark) RLM (BR517) (12 dtex, 44 mm, manufactured by Kaneka Corporation), and 30 parts by weight of the commercially available acrylic fiber Kanekalon (registered trademark) AHD (10) (4.4 dtex, 32 mm, manufactured by Kaneka Corporation) (Comparative Example 1) and by blending 40 parts by weight of the shrinkable fiber obtained in Production Example 5, 30 parts by weight of the commercially available acrylic fiber Kanekalon (registered trademark) RLM (BR517) (12 dtex, 44 mm, manufactured by Kaneka Corporation), and 30 parts by weight of the commercially available acrylic fiber Kanekalon (registered trademark) AHD (10) (4.4 dtex, 32 mm, manufactured by Kaneka Corporation) (Comparative Example 2). The respective long pile portions had a mean pile length of 20 mm. According to the results of the sensory evaluation of the appearance shown in Table 2, the pile fabric of Comparative Example 1 had a relatively unclear step and the extremely poor animal hair-like appearance, and the pile fabric of Comparative Example 2 had a relatively unclear step and the poor animal hair-like appearance.

### EXAMPLE 4, AND COMPARATIVE EXAMPLES 3 AND 4

The fibers obtained in Production Example 2 were crimped and cut to 38 mm. Pile fabrics were obtained by blending 80 parts by weight of the fiber obtained in Production Example 2 and 20 parts by weight of a dyed commercially available acrylic fiber Kanekalon (registered trademark) RCL (17 dtex, 51 mm, manufactured by Kaneka Corporation) (Example 4), by blending 80 parts by weight of a commercially available acrylic fiber Kanekalon (registered trademark) AHP (4.4 dtex, 32 mm, manufactured by Kaneka Corporation) and 20 parts by weight of the dyed commercially available acrylic fiber Kanekalon (registered trademark) RCL (17 dtex, 51 mm, manufactured by Kaneka Corporation) (Comparative Example 3), and by blending 80 parts by weight of a commercially available acrylic fiber Bonnel (registered trademark) V85 (2.2 dtex, 3.8 mm, manufactured by Mitsubishi Rayon Co., Ltd.) and 20 parts by weight of the dyed commercially available acrylic fiber Kanekalon (registered trademark) RCL (17 dtex, 51 mm, manufactured by Kaneka Corporation) (Comparative Example 4). The respective long pile portions had a mean pile length of 15 mm. According to the results of the sensory evaluation of the appearance shown in Table 2, the pile fabric of Example 4 had a distinct step and the good animal hair-like appearance, while each of the pile fabrics of Comparative Examples 3 and 4 had a relatively unclear step and the extremely poor animal hair-like appearance.

The dyed commercially available acrylic fiber RCL used in Example 4 and Comparative Examples 3 and 4 was obtained according to the following procedure. A dyeing solution was prepared by mixing 0.285% omf of Maxilon Golden Yellow GL 200%, 0.0975% omf of Maxilon Red GRL 200%, and 0.057% omf of Maxilon Blue GRL 300% (all manufactured by Chiba Specialty Chemicals K.K) as dye stuffs and 0.5 g/l of Ultra MT#100 (manufactured by Mitejima Chemicals Corp.) as a dyeing assistant. The acrylic fiber RCL was soaked in the dyeing solution, as the temperature raised from room temperature at a rate of 3° C./min and was held at 98° C. for 60 minutes. After completion of dyeing, the dyeing solution was cooled down. The dyed fibers were taken out, were centrifugally dewatered, and was dried at 60° C.

### COMPARATIVE EXAMPLE 5

The fibers obtained in Production Example 7 were crimped and cut to 38 mm. A pile fabric was obtained by blending 40 parts by weight of the fiber obtained in Production Example 7 and 60 parts by weight of a commercially available acrylic fiber Kanekalon (registered trademark) AH(740) (5.6 dtex, 38 mm, manufactured by Kaneka Corporation). The long pile portion had a mean pile length of 15 mm. According to the results of the sensory evaluation of the appearance, the pile fabric of Comparative Example 5 had a relatively unclear step and the extremely poor animal hair-like appearance.

### INDUSTRIAL APPLICABILITY

The present invention is directed to a step pile fabric, wherein a medium pile portion and/or a short pile portion of a pile portion contain acrylic fibers having a specific optical transmittance, a specific maximum surface reflectance, and enhanced visibility of respective fibers. This gives a distinct step and the good animal hair-like appearance to the resulting pile fabric, compared with prior art pile fabrics. Setting the width of the longitudinal axis on cross section of the acrylic fibers in a desired range or application of the acrylic fibers that have a flat cross section and the greater thickness than other fibers desirably makes the step more distinct and produces pile fabrics having a sufficient volume and good recovery, such as high piles and boas. The technique of the present invention is thus applicable to a wide range of products including cloths, toys (stuffed toys), and interior goods.

1-19. (canceled)

20. A method for producing a step pile fabric comprising a long pile portion, a medium length pile portion and a short pile portion, comprising the steps of:
a) preparing an acrylic fiber (A) which has
a1) a dry heat shrinkage rate of 10 percent to 50 percent,
a2) 1.2 parts to 30 parts by weight of a white pigment having a maximum particle size of not greater than 0.8 μm based on 100 parts by weight of an acrylic copolymer, and
a3) a transmittance of light in a range of 15 percent to 70 percent in a direction of width of the fiber with a maximum surface reflectance of light, in a range of 30 percent to 80 percent at an incident angle of 60 degrees in a direction of length of the fiber;
b) preparing three kinds of fiber with different dry shrinkage rates for long pile portion fibers, medium pile portion fibers and short pile portion fibers, wherein the fiber for the medium pile portion and/or the fiber for the short pile portion contains the acrylic fiber (A) and the fiber for the long portion contains substantially no acrylic fiber (A);
c) producing a pile fabric comprising the three kinds of fiber; and
d) heat treating the pile fabric comprising the three kinds of fiber to shrink fibers to form steps in the pile fabric, wherein the pile portions including a pile portion other than the long pile portion in pile fabric which has been produced contain at least 3 percent by weight of an acrylic fiber (A) based on the entire pile portions.

21. The method according to claims 20 or 27, wherein the medium pile portion and/or the short pile portion in the produced pile fabric contain the acrylic fiber (A) in a range of 20 percent to 80 percent by weight of the entire pile portion.

22. The method according to claim 21, wherein the medium pile portion of the pile fabric in the produced pile fabric contains the acrylic fiber (A) in a range of 20 percent to 50 percent by weight based on the entire pile portion.

23. The method according to claim 21, the pile fabric satisfying relations of |LM−LG|>40 and |LM−LS|>50, where LG, LM, and LS respectively denote a lightness of the long pile portion, a lightness of the medium pile portion, and a lightness of the short pile portion.

24. The method according to claim 21, wherein a difference between a mean pile length of the long pile portion and a mean pile length of the medium pile portion is not less than 2 mm, the mean pile length of the medium pile portion is longer by at least 1 mm than a mean pile length of the short pile portion, and the mean pile length of the long pile portion ranges from 9 mm to 34 mm.

25. The method according to claim 23, wherein the mean pile length of the long pile portion ranges from 12 mm to 25 mm.

26. The method according to claims 20 or 27, wherein the acrylic fiber (A) has a greater fineness than the mean fineness of fibers of the long pile portion.

27. The method according to claim 20, wherein said white pigment is a titanium oxide.

28. The method according to claims 20 or 27, wherein the acrylic fiber (A) has a length of a longitudinal axis in a range of 50 μm to 300 μm on cross section of the fiber.

29. The method according to claims 20 or 27, wherein the acrylic fiber (A) has a flat cross section.
